(19) United States
(12) Patent Application Publication
(10) Pub. No.: US 2026/0139987 A1
(43) Pub. Date: May 21, 2026

(54) A LEVEL SENSING SYSTEM AND A METHOD OF OPERATING A LEVEL SENSING SYSTEM

(71) Applicant: HYDRO INTERNATIONAL LTD., Clevedon, Bristol (GB)

(72) Inventor: Tim Campbell, Dunblane, Perthshire (GB)

(73) Assignee: HYDRO INTERNATIONAL LTD., Clevedon, Bristol (GB)

(21) Appl. No.: 19/120,255

(22) PCT Filed: Oct. 11, 2023
(86) PCT No.: PCT/EP2023/078195

§ 371 Date: Apr. 11, 2025

(30) Foreign Application Priority Data
Oct. 11, 2022 (GB) 2214994.2

(51) Int. Cl. G01F 23/26

(52) U.S. Cl. CPC G01F 23/26

(57) ABSTRACT

A level sensing system including a level sensor disposed in a first and second medium. The level sensor includes: a spring-mass system disposed within a sensor housing, the spring-mass system comprising a magnetic mass and a spring that couples the magnetic mass to the sensor housing; an electrical conductor configured to generate an oscillating magnetic field for driving oscillating motion of the magnetic mass; and a sensor configured to sense a back electromotive force in the electrical conductor caused by the oscillating motion of the magnetic mass. The level sensing system comprises a processor configured to: determine a frequency based on the sensed back electromotive force or the oscillating motion of the magnetic mass; determine whether the frequency is greater or less than a threshold value; determine whether the level sensor is or is not disposed partly or wholly in the first and/or second medium.

### CROSS REFERENCE TO RELATED APPLICATIONS

This application is a U.S. National Stage Application under 35 U.S.C. § 371 of PCT/EP2023/078195, filed Oct. 11, 2023, which claims priority to United Kingdom Patent Application No. 2214994.2, filed Oct. 11, 2022, the entire contents of each of which are incorporated herein.

### TECHNICAL FIELD

The present disclosure relates to a level sensing system and a method of operating a level sensing system.

### BACKGROUND

It is known for level sensing systems to be used to determine whether a medium has reached a predefined level within a volume. However, existing level sensing systems are known to either be inaccurate or expensive to manufacture. It is therefore desirable to provide an improved level sensing system and a method of operating a level sensing system that overcomes these issues.

### STATEMENTS OF THE DISCLOSURE

According to an aspect there is described a level sensing system comprising a level sensor. The level sensor is configured to be disposed in at least a first medium and a second medium. The level sensor comprises: a sensor housing; a spring-mass system disposed within the sensor housing, the spring-mass system comprising a magnetic mass and a spring that couples the magnetic mass to the sensor housing; an electrical conductor configured to generate an oscillating magnetic field for driving oscillating motion of the magnetic mass; and a sensor configured to sense a back electromotive force in the electrical conductor caused by the oscillating motion of the magnetic mass. The level sensing system comprises a processor configured to: determine a frequency based on the sensed back electromotive force, the frequency being a frequency of the sensed back electromotive force or a frequency of the oscillating motion of the magnetic mass; determine whether the determined frequency meets a first condition and/or meets a second condition, wherein the first condition is the determined frequency being greater than a threshold value, wherein the second condition is the determined frequency being less than a threshold value; determine that the level sensor is not disposed partly or wholly in the first medium and/or determine that the level sensor is disposed partly or wholly in the second medium upon determining that the determined frequency meets the first condition and/or does not meet the second condition; and determine that the level sensor is disposed partly or wholly in the first medium and/or determine that the level sensor is not disposed partly or wholly in the second medium upon determining that the determined frequency does not meet the first condition and/or does meet the second condition.

According to an aspect there is described a level sensing system comprising a level sensor. The level sensor is configured to be disposed in at least a first medium and a second medium. The level sensor comprises: a sensor housing; a spring-mass system disposed within the sensor housing, the spring-mass system comprising a magnetic mass and a spring that couples the magnetic mass to the sensor housing; an electrical conductor configured to generate an oscillating magnetic field for driving oscillating motion of the magnetic mass; and a sensor configured to sense a back electromotive force in the electrical conductor caused by the oscillating motion of the magnetic mass during a first period of time and sense a back electromotive force in the electrical conductor caused by the oscillating motion of the magnetic mass during a second period of time after the first period of time. The level sensing system comprises a processor configured to: determine a first frequency based on the sensed back electromotive force, the first frequency being a frequency of the sensed back electromotive force or a frequency of the oscillating motion of the magnetic mass during the first period of time; determine a second frequency based on the sensed back electromotive force, the second frequency being a frequency of the sensed back electromotive force or a frequency of the oscillating motion of the magnetic mass during the second period of time; determine a change between the first frequency and the second frequency or determine a rate of change of frequency based on the first frequency and the second frequency; determine whether the determined change or the determined rate of change meets a first condition and/or meets a second condition, wherein the first condition is the determined change being greater than a threshold value or the determined rate of change being greater than a threshold value, wherein the second condition is the determined change being less than a threshold value or the determined rate of change being less than a threshold value; determine that the level sensor is not disposed partly or wholly in the first medium and/or determine that the level sensor is disposed partly or wholly in the second medium upon determining that the determined change or rate of change meets the first condition and/or does not meet the second condition; and determine that the level sensor is disposed partly or wholly in the first medium and/or determine that the level sensor is not disposed partly or wholly in the second medium upon determining that the determined change or rate of change does not meet the first condition and/or does meet the second condition.

The sensor may be configured to sense the back electromotive force in the electrical conductor caused by the oscillating motion of the magnetic mass during the first period of time upon the level sensing system receiving a user input indicating the level sensor is disposed in a predefined medium.

The level sensor may further comprise a supporting arm to which the sensor housing is attached. The oscillating motion of the magnetic mass may effect oscillating motion of the supporting arm.

The supporting arm may be formed by a printed circuit board.

The sensor housing and the supporting arm may be disposed at least in part within a flexible casing configured to seal the sensor housing from an external environment.

The elasticity of the flexible casing may be greater than the elasticity of the supporting arm.

The level sensor may further comprise a rigid casing. The flexible casing may be disposed at least partly within the rigid casing.

The rigid casing may comprise an opening. The flexible casing may be exposed to the external environment through the opening.

The rigid casing may comprise a first prong and a second prong that extend from a base of the rigid casing. The first prong and the second prong may be separated by a gap and at least in part define the opening.

The flexible casing may be disposed at least in part within the gap. The sensor housing may be disposed between the first and second prongs.

The magnetic mass, the spring and the electrical conductor may be aligned along an axis that extends through the gap.

The width of a portion of the flexible casing disposed at least in part within the gap measured in the direction of the axis may taper toward a distal end of the flexible casing.

The width of the first prong measured in the direction of the axis and the width of the second prong measured in the direction of the axis may be less than the width of the base measured in the direction of the axis.

The first and second prongs may extend from the base beyond a distal end of the flexible casing.

The processor may be disposed within the base.

The level sensor may comprise the processor.

The level sensing system may further comprise a transmitter configured to wirelessly transmit the sensed back electromotive force to a remote location. The remote location may comprise the processor.

According to an aspect there is described a method of operating a level sensing system as stated in any preceding statement. The method comprises: generating, by the electrical conductor, an oscillating magnetic field to drive oscillating motion of the magnetic mass; sensing, by the sensor, a back electromotive force in the electrical conductor caused by the oscillating motion of the magnetic mass; determining, by the processor, a frequency based on the sensed back electromotive force, the frequency being a frequency of the sensed back electromotive force or a frequency of the oscillating motion of the magnetic mass; determining, by the processor, whether the determined frequency meets a first condition and/or meets a second condition, wherein the first condition is the determined frequency being greater than a threshold value, wherein the second condition is the determined frequency being less than a threshold value; determining, by the processor, that the level sensor is not disposed partly or wholly in the first medium and/or determine that the level sensor is disposed partly or wholly in the second medium upon determining that the determined frequency meets the first condition and/or does not meet the second condition; and determining, by the processor, that the level sensor is disposed partly or wholly in the first medium and/or determine that the level sensor is not disposed partly or wholly in the second medium upon determining that the determined frequency does not meet the first condition and/or does meet the second condition.

According to an aspect there is described a method of operating a level sensing system as stated in any preceding statement. The method comprises: generating, by the electrical conductor, an oscillating magnetic field to drive oscillating motion of the magnetic mass; sensing, by the sensor, a back electromotive force in the electrical conductor caused by the oscillating motion of the magnetic mass during a first period of time and sensing a back electromotive force in the electrical conductor caused by the oscillating motion of the magnetic mass during a second period of time after the first period of time; determining, by the processor, a first frequency based on the sensed back electromotive force, the first frequency being a frequency of the sensed back electromotive force or a frequency of the oscillating motion of the magnetic mass during the first period of time; determining, by the processor, a second frequency based on the sensed back electromotive force, the second frequency being a frequency of the sensed back electromotive force or a frequency of the oscillating motion of the magnetic mass during the second period of time; determining, by the processor, a change between the first frequency and the second frequency or determining a rate of change of frequency based on the first frequency and the second frequency; determining, by the processor, whether the determined change or the determined rate of change meets a first condition and/or meets a second condition, wherein the first condition is the determined change being greater than a threshold value or the determined rate of change being greater than a threshold value, wherein the second condition is the determined change being less than a threshold value or the determined rate of change being less than a threshold value; determining, by the processor, that the level sensor is not disposed partly or wholly in the first medium and/or determine that the level sensor is disposed partly or wholly in the second medium upon determining that the determined change or rate of change meets the first condition and/or does not meet the second condition; and determining, by the processor, that the level sensor is disposed partly or wholly in the first medium and/or determine that the level sensor is not disposed partly or wholly in the second medium upon determining that the determined change or rate of change does not meet the first condition and/or does meet the second condition.

The method may further comprise disposing the level sensor in a predefined medium. The level sensing system may receive a user input indicating the level sensor is disposed in the predefined medium. The method may comprise sensing, by the sensor, the back electromotive force in the electrical conductor caused by the oscillating motion of the magnetic mass during the first period of time upon the level sensing system receiving the user input indicating the level sensor is disposed in the predefined medium.

The steps of generating, by the electrical conductor, an oscillating magnetic field to drive oscillating motion of the magnetic mass and sensing, by the sensor, a back electromotive force in the electrical conductor caused by the oscillating motion of the magnetic mass may be carried out concurrently.

The method may further comprise stopping generating, by the electrical conductor, the oscillating magnetic field prior to sensing, by the sensor, the back electromotive force in the electrical conductor caused by the oscillating motion of the magnetic mass.

The method may further comprise, upon determining that the level sensor is not disposed at least partly in the medium, carrying out a first process. The method may further comprise, upon determining that the level sensor is disposed at least partly in the medium, carrying out a second process.

### LIST OF FIGURES

For a better understanding of the present disclosure, and to show more clearly how it may be carried into effect, reference will now be made, by way of example, to the accompanying drawings, in which:

FIG. 1 is a perspective view of a separator comprising a level sensing system;

FIG. 2 is a side view of a level sensor of the level sensing system;

FIG. 3 is a side view of a flexible casing of the level sensor;

FIG. 4 is a side view showing electronic circuitry of the level sensor within the flexible casing;

FIG. 5 is further side view of the level sensor;

FIG. 6 is a side view showing the electronic circuitry in isolation;

FIG. 7 is a further side view of the level sensor;

FIG. 8 is a close-up cross-sectional schematic view of the sensor housing and components disposed within the sensor housing;

FIG. 9 is a flowchart of a first method of operating the level sensing system;

FIG. 10 is a further perspective view of the separator;

FIG. 11 is a graph showing how the frequency determined by a processor of the level sensor varies over time;

FIG. 12 is a flowchart of a second method of operating the level sensing system;

FIG. 13 is a flowchart of a third method of operating the level sensing system;

FIG. 14 is a flowchart of a fourth method of operating the level sensing system; and

FIG. 15 is a flowchart of a fifth method of operating the level sensing system.

### DETAILED DESCRIPTION

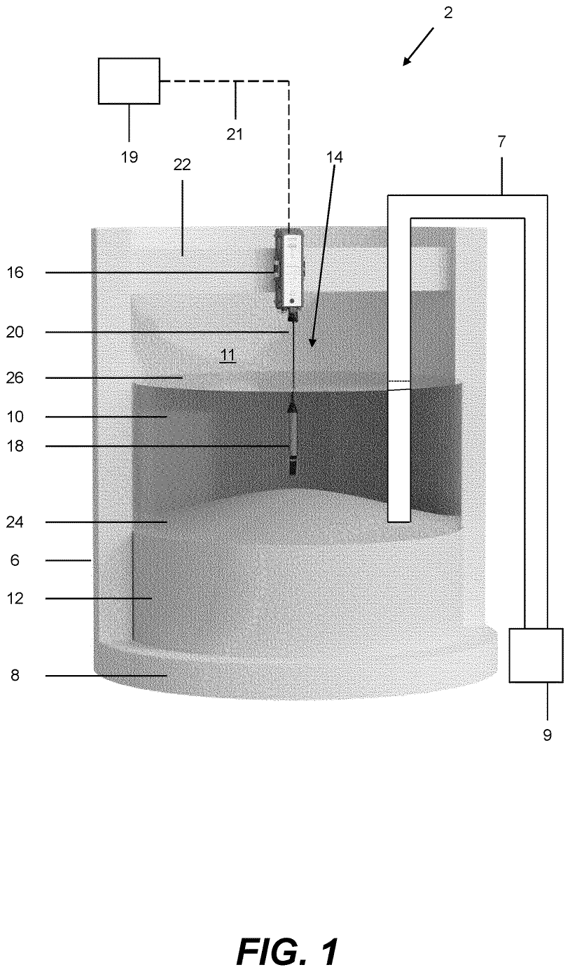

FIG. 1 shows a separator 2 comprising a chamber 4 having a side wall 6 and a base 8. The chamber 4 is configured to retain water 10. Sediment 12 (also referred to herein as the first medium) may be suspended within the water 10 and may settle to the bottom of the chamber 4 during operation of the separator 2. The upper level 24 of the sediment 12 within the chamber 4 may change during operation of the separator 2. Likewise, the upper level 26 of water 10 (also referred to herein as the second medium) within the chamber 4 may change during operation of the separator 2. The density of the second medium may be less than the density of the first medium. The damping effect of the second medium may be less than the damping effect of the first medium. A pipe 7 is disposed in the chamber 4 and has an opening (not shown) located near the bottom of the chamber 4. The pipe 7 is connected at its other end to a suction device 9. The suction device 9 is able to pump the sediment 12 out of the chamber 4 via the pipe 7.

The chamber 4 is provided with a level sensing system 14. The level sensing system 14 comprises a remote telemetry unit (RTU) 16, a level sensor 18 connected to the remote telemetry unit 16 by a wire 20, and a remote control system 19 connected to the remote telemetry unit 16 by a wireless connection 21. The remote control system 19 may be a cloud system. The remote telemetry unit 16 is configured to receive information from the level sensor 18 via the wire 20 and wirelessly transmit the information to the remote control system 19 via the wireless connection 21. The remote telemetry unit 16 comprises a battery (not shown) for powering the level sensor 18 via the wire 20. The remote telemetry unit 16 is fixedly connected to a beam 22 extending across an upper portion of the chamber 4. The level sensor 18 is suspended from the remote telemetry unit 16 by the wire 20 and extends downwards into a lower portion of the chamber 4. In the configuration shown in FIG. 1, the level sensor 18 is disposed in the water 10 (i.e. the second medium) and is not disposed in the sediment 12 (i.e. the first medium).

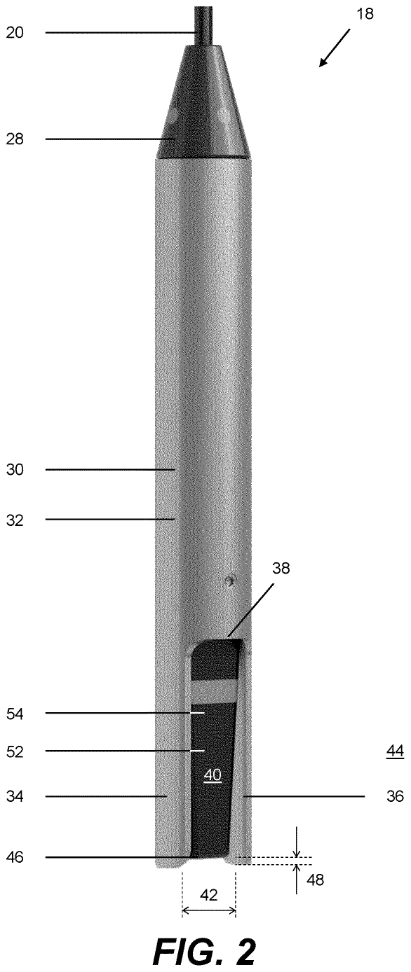

FIG. 2 is a side view of the level sensor 18 in isolation. The level sensor 18 comprises a cap 28, a rigid casing 30 and a flexible casing 54. The rigid casing 30 comprises a base 32, a first prong 34 and a second prong 36. The base 32 is generally tubular. The cap 28 forms a watertight seal between the rigid casing 30 and the wire 20. The flexible casing 54 is disposed partly within the rigid casing 30. In particular, a proximal portion 50 of the flexible casing 54 (not shown in FIG. 2) is disposed within the tubular base 32. The first and second prongs 34, 36 extend from the base 32 and are separated by a gap 42. The rigid casing 30 defines an opening 40 into an interior of the casing 30. The opening 40 is defined by a distal end 38 of the base 32 and the first and second prongs 34, 36. A distal portion 52 of the flexible casing 54 is exposed to an external environment 44 through the opening 40 and is disposed within the gap 42. The first and second prongs 34, 36 extend from the base 32 beyond a distal end 46 of the flexible casing 54. Accordingly, the ends of the first and second prongs 34, 36 are separated from the end of the flexible casing 54 by a distance 48.

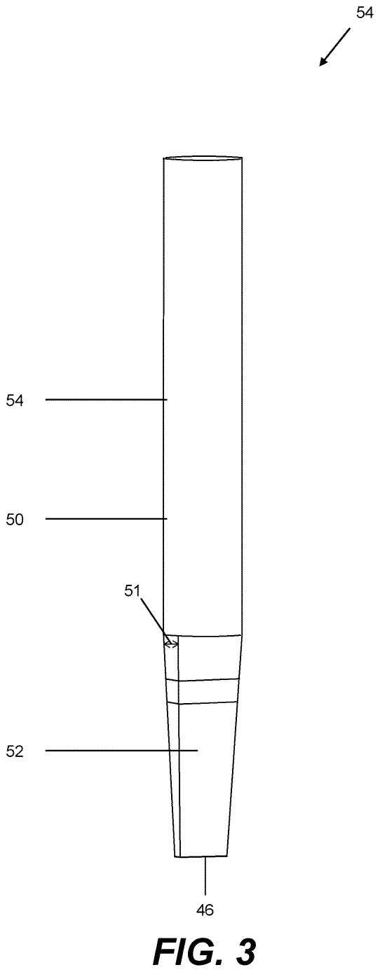

FIG. 3 is a side view of the flexible casing 54 in isolation. The proximal portion 50 of the flexible casing 54 is substantially tubular. As shown, the distal portion 52 has a width 51 that tapers down toward the distal 46 end of the flexible casing 54. The flexible casing 54 may be made from a waterproof material. The flexible casing 54 may be formed of a plastic or rubber, for example. The flexibility of the flexible casing 54 is greater than the flexibility of the rigid casing 30. That is, the stiffness or rigidity of the flexible casing 54 is less than the stiffness or rigidity of the rigid casing 30. Furthermore, the elasticity of the flexible casing 54 is greater than the elasticity of the rigid casing 30. That is, the elastic modulus of the flexible casing 54 is less than the elastic modulus of the rigid casing 30. This facilitates operation of the level sensor 18 in the manner described below while allowing the rigid casing 30 to protect the flexible casing 54 and the components within the rigid casing 30.

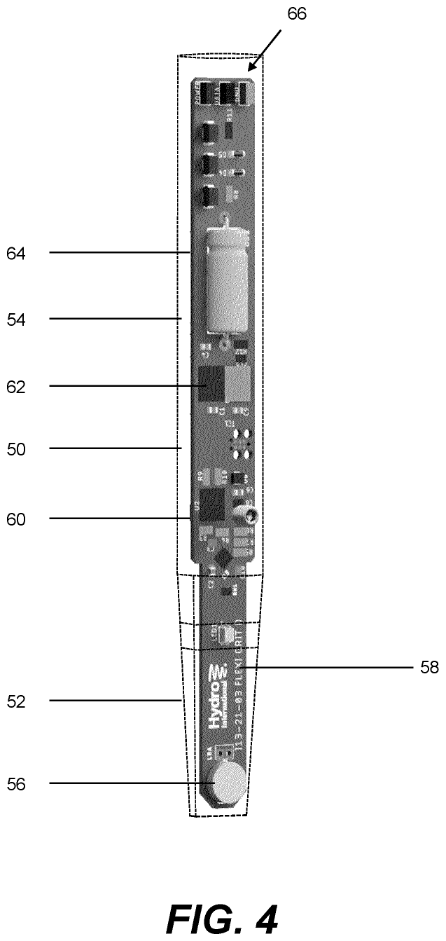

FIG. 4 is a side view showing the flexible casing 32 in phantom. As shown, electronic circuitry 66 is disposed within the flexible casing 54. The flexible casing 54 may be overmoulded over the electronic circuitry 66. In addition to other components, the electronic circuitry 66 comprises a printed circuit board (PCB) 60, a sensor housing 56 and a processor 62. A first portion 64 of the PCB 60 is disposed in the proximal portion 50 of the flexible casing 54. The processor 62 is attached to the first portion 64 of the PCB 60, and, thus, is disposed in the proximal portion 50 of the flexible casing 54. The PCB 60 further comprises a supporting arm or tab 58 that extends from the first portion 64 into the distal portion 52 of the flexible casing 54. The supporting arm 58 is elongate (i.e. its length is long in relation to its width). The sensor housing 56 is attached to the supporting arm 58 such that the sensor housing 56 is also disposed within the distal portion 52 of the flexible casing 54. The flexible casing 54 seals the sensor housing 56 and the other components of the electronic circuitry 66 from the external environment 44.

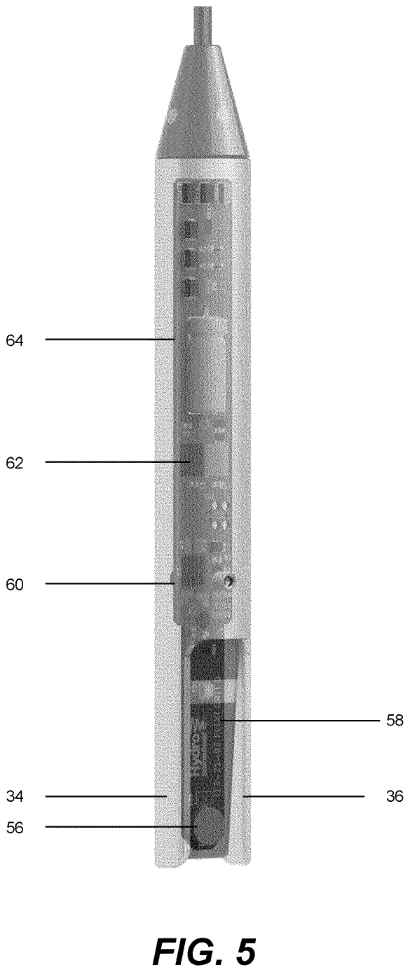

FIG. 5 is a further side view of the level sensor 18. The view shown in FIG. 5 corresponds to the view shown in FIG. 2, however the rigid casing 30 is shown as being semi-transparent and the proximal portion 50 of the flexible casing 54 is not shown. As shown in FIG. 5, the processor 62 is disposed within the base 32 and the sensor housing 56 is disposed between the first and second prongs 34, 36. Accordingly, in the arrangement shown in FIG. 5, the level sensor 18 comprises the processor 62.

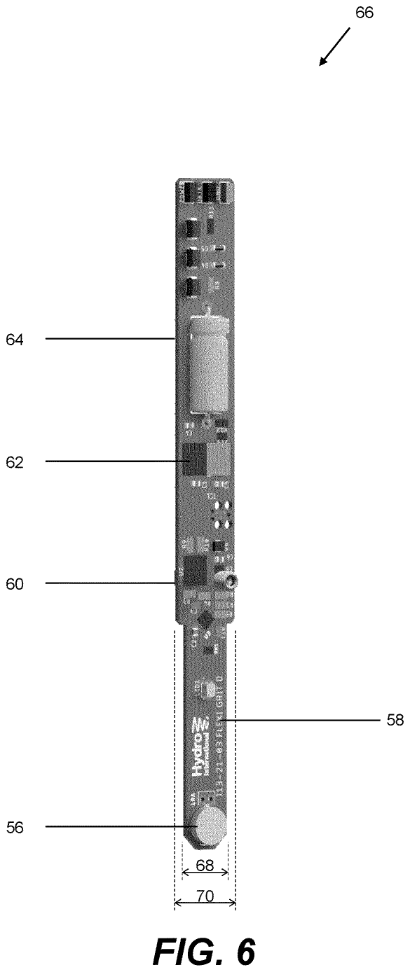

FIG. 6 is a side view showing the electronic circuitry 66 in isolation. As shown, the width 68 of the supporting arm 58 is less than the width 70 of the first portion 64 of the PCB 60. The supporting arm 58 is able to move in and out of the plane of the supporting arm 58 during operation of the level sensor 18. The sensor housing 56 being disposed toward a distal end of the supporting arm 58 allows it to move in and out of the plane of the supporting arm 58 by a greater extent than if it were located at a proximal end of the supporting arm 58 (i.e. closer to where the supporting arm 58 is attached to the first portion 64 of the PCB 60). The elasticity of the flexible casing 54 is greater than the elasticity of the supporting arm 58 so as to limit the amount of damping that the flexible casing 54 exerts on the movement of the supporting arm 58 and the sensor housing 56.

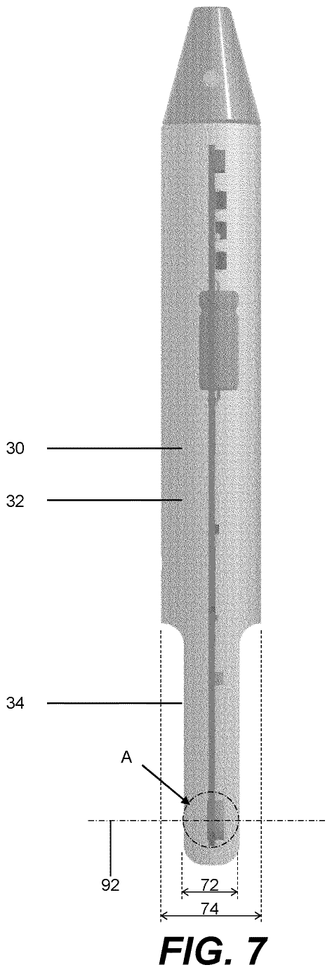

FIG. 7 is a further side view of the level sensor 18. In FIG. 7, the rigid casing 30 is shown as being semi-transparent and the flexible casing 54 is not shown. As shown, the width 72 of the supporting arm 58 is less than the width 74 of the base 32 of the rigid casing 30. The first and second prongs 34, 36 are disposed on a central plane of the rigid casing 30 such that rigid casing 30 is substantially symmetrical.

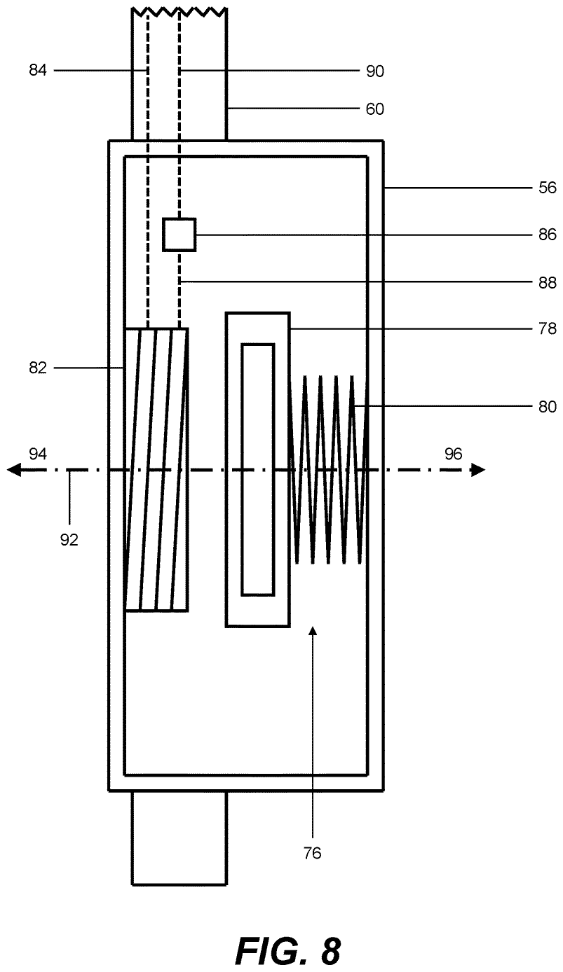

FIG. 8 is a close-up cross-sectional view of the sensor housing 56. Also shown is a portion of the PCB 60 to which the sensor housing 56 is attached. The area of the close-up cross-sectional view of FIG. 8 is denoted by the letter A in FIG. 7.

As shown, a spring-mass system 76 is disposed within the sensor housing 56. The spring-mass system 76 comprises a magnetic mass 78 and a spring 80. The spring 80 couples the magnetic mass 78 to the interior of the sensor housing 56. The coupling is shown as being direct in FIG. 8, although it may alternatively be an indirect coupling between the magnetic mass 78 to the interior of the sensor housing 56. An electrical conductor 82 is also disposed in the sensor housing 56. The electrical conductor 82 may be any suitable electrical conductor such as an electromagnetic coil or voice coil. The electrical conductor 82 is electrically coupled to the processor 62 (not shown in FIG. 8) by a first electrical line 84. A sensor 86 is connected to the electrical conductor 82 by a second electrical line 88. The sensor 86 is connected to the processor 62 by a third electrical line 90.

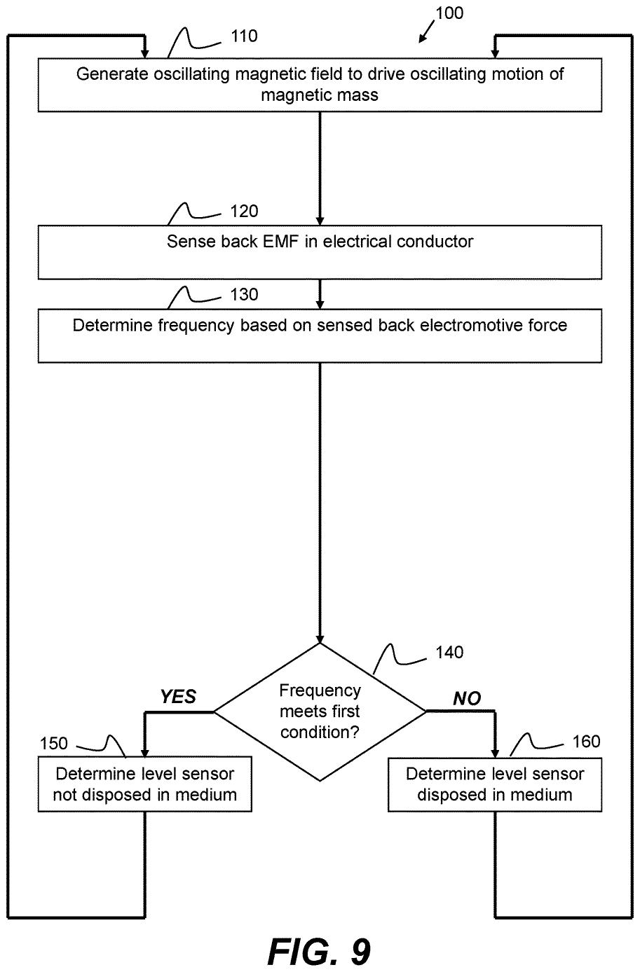

FIG. 9 is a flowchart of a first method 100 of operating the level sensing system 14. In a first step 110 of the first method 100, the electrical conductor 82 generates an oscillating magnetic field for driving oscillating motion of the magnetic mass 78. In particular, the electrical conductor 82 is supplied with alternating current via the first electrical line 84, which causes the electrical conductor 82 to generate the oscillating magnetic field. This oscillating magnetic field induces simple harmonic motion of the magnetic mass 78. That is, the magnetic mass 78 periodically moves along an axis of movement 92 along which the magnetic mass 78, the spring 80 and the electrical conductor 82 are aligned. The magnetic mass 78 moves away from and towards an equilibrium position (shown in FIG. 8). During such movement, the magnetic mass 78 moves towards the electrical conductor 82 in a first direction 94 and away from the electrical conductor 82 in a second direction 96. Oscillating motion of the magnetic mass 78 effects oscillating motion of the supporting arm 58, and, thus, oscillating motion of the flexible casing 54.

The frequency at which the magnetic mass 78 oscillates depends on the medium within which the level sensor 18 is disposed. For example, when the level sensor 18 is disposed in air 11, the magnetic mass 78 oscillates (i.e. resonates) relatively close to its natural frequency, for example at a frequency of approximately 182 Hertz. When the level sensor 18 is disposed in the sediment 12 (i.e. the first medium), the sediment 12 dampens movement of the level sensor 18, and, thus, the oscillation of the magnetic mass 78. This causes the magnetic mass 78 to oscillate at a lower frequency, for example at a frequency of approximately 155 Hertz. When the level sensor 18 is disposed in water 10 (i.e. the second medium), the water 10 dampens movement of the level sensor 18, and, thus, the oscillation of the magnetic mass 78. However, the amount by which the water 10 dampens movement of the level sensor 18 and the magnetic mass 78 is less than the amount by which the sediment 12 dampens movement of the level sensor 18 and the magnetic mass 78. Accordingly, when the level sensor 18 is disposed in water 10, the magnetic mass 78 oscillates at a frequency between those indicated above, for example at a frequency of approximately 160 Hertz.

In a second step 120 of the first method 100, the sensor 86 senses a back electromotive force in the electrical conductor 82. This back electromotive force is caused by the oscillating motion of the magnetic mass 78 relative to the electrical conductor 82. It will be appreciated that the first and second steps 110, 120 may be carried out concurrently. The first method 100 then proceeds to a third step 130.

In the third step 130, the processor 62 determines a frequency based on the sensed back electromotive force (i.e. the back electromotive force sensed in the second step 120). The frequency determined by the processor 62 may be the frequency of the sensed back electromotive force. Alternatively, the frequency determined by the processor 62 may be a frequency of the oscillating motion of the magnetic mass 78 determined based on the sensed back electromotive force. The first method 100 then proceeds to a fourth step 140.

In the fourth step 140, the processor 62 determines whether the determined frequency meets a first condition. The first condition is the determined frequency being greater than a threshold value. The threshold value may be any suitable value, for example 160 Hertz. The first method 100 then proceeds to a fifth step 150 or a sixth step 160 depending on the outcome of the fourth step 140.

In the fifth step 150, upon determining that the determined frequency does meet the first condition, the processor 62 determines that the level sensor 18 is not disposed in the first medium (either partly or wholly). The first method 100 then proceeds to the first step 110 where the first method 100 may be repeated. It will be appreciated that, in the fifth step 150, upon determining that the determined frequency meets the first condition, the processor 62 may instead positively determine that the level sensor 18 is disposed in a second medium (e.g. water 10).

In the sixth step 160, upon determining that the determined frequency does not meet the first condition, the processor 62 determines that the level sensor 18 is disposed in the first medium (either partly or wholly). The first method 100 then proceeds to the first step 110 where the first method 100 may be repeated. The first method 100 may be repeated continuously or intermittently (e.g. 5 seconds every 5 minutes).

Returning to FIG. 8, as shown, the axis 92 extends perpendicular to the plane of the PCB 60 (rather than along the plane of the PCB, for example). This increases the extent by which oscillation of the magnetic mass 78 is dampened by the medium within which the level sensor 18 is located, thus improving the sensitivity of the level sensor 18. The extent by which oscillation of the magnetic mass 78 is dampened by the medium within which the level sensor 18 is located is also increased as a result of the axis 92 extending through the gap 42 (e.g. rather than through the first and second prongs 34, 36).

Returning to FIG. 7, since the the width 72 of the first prong 34 in the direction of the axis 92 and the width 72 of the second prong 36 in the direction of the axis 92 is less than the width 75 of the base 32 in the direction of the axis 92, the first and second prongs 34 minimise undesirable lateral movement of the sensor housing 56 and the components within the sensor housing 56 (which may result in damage to the level sensor 18 or reduced sensitivity of the level sensor 18) while still allowing sufficient movement of the sensor housing 56 in a desirable direction (i.e. along the direction of the axis 92).

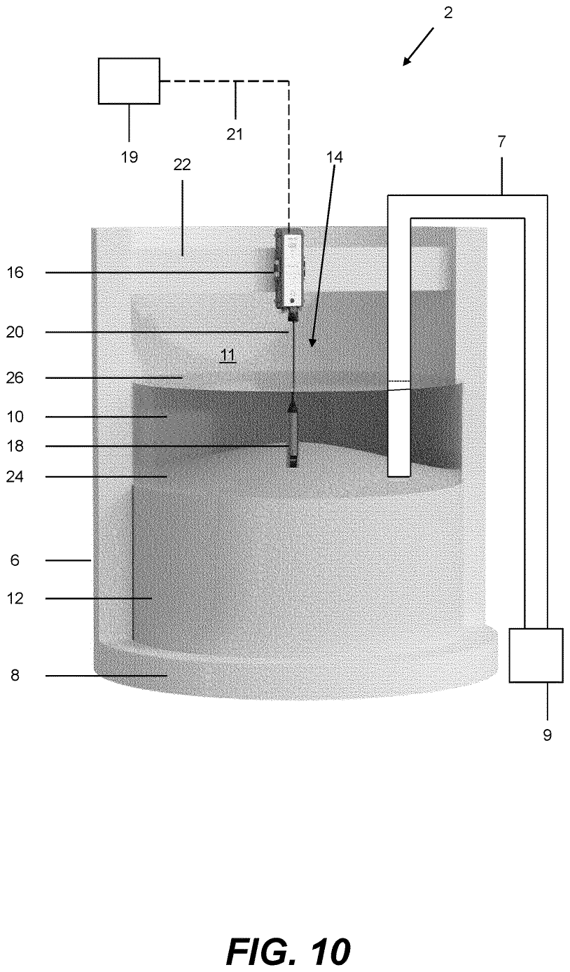

FIG. 10 is an example of a configuration of the separator 2 in which the level sensor 18 is disposed at least partly in the sediment 12. It will be appreciated that the level sensor 18 need only be partly (i.e. not wholly) disposed in the sediment 12 for the frequency of oscillation of the magnetic mass 78 to be reduced (i.e. from the level it would oscillate at if the level sensor 18 were wholly disposed in water 10). The level sensor 18 is therefore configured to be disposed in (i.e. alternately disposed in) a first medium 12 and a second medium 10,

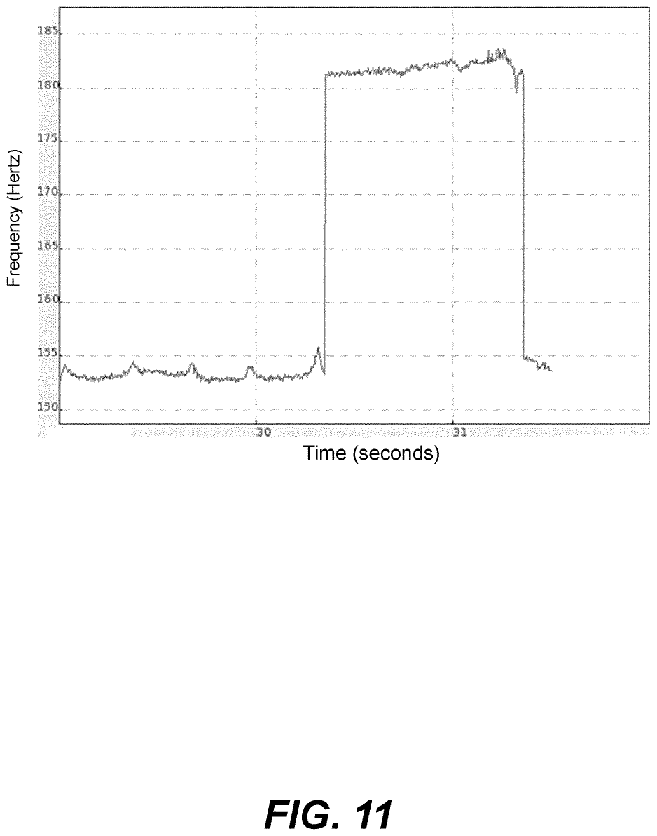

FIG. 11 is a graph showing how the frequency determined by the processor 62 varies over time based on the location of the level sensor 18. During a first period of time between 29 seconds and approximately 30.35 seconds, the determined frequency is approximately 153 Hertz. In the abovementioned example in which 160 Hertz is the threshold, the processor 62 would therefore determine that the level sensor 18 is disposed at least partly in the sediment 12 during the first period of time. In contrast, during a second period of time between approximately 30.35 seconds and approximately 31.35 seconds, the determined frequency is approximately 181 Hertz. In the abovementioned example in which 160 Hertz is the threshold, the processor 62 would therefore determine that the level sensor 18 is not disposed at least partly in the sediment 12 during the second period of time. During a third period of time between approximately 31.35 seconds and approximately 31.5 seconds, the determined frequency is approximately 154 Hertz. In the abovementioned example in which 160 Hertz is the threshold, the processor 62 would therefore determine that the level sensor 18 is again disposed at least partly in the sediment 12 during the third period of time.

In contrast to existing level sensor designs that incorporate separate piezoelectric driving and sensing elements, the level sensor and method described herein is able to achieve greater sensitivity at lower cost. For example, in such existing level sensor designs, a large voltage must be applied to the driving piezoelectric element for the sensing piezoelectric element to produce only a relatively very small voltage. This means that the detection circuitry of such existing level sensor must be able to detect variations in voltage to very high sensitivity in order to distinguish accurately between mediums. The complexity of such circuitry is further complicated by the fact that there is a very small window of time within which the piezoelectric echo may be measured, and this must be done after the piezoelectric drive has been deactivated. In contrast, by instead providing a level sensor and method as described herein, the input voltage (i.e. the driving voltage supplied to the electrical conductor 82) and the sensed voltage used to differentiate between mediums (i.e. the back EMF) are comparatively similar in magnitude, which improves resolution and reduces the cost of associated components and circuitry. The accuracy of the level sensor and associated method is further improved by not having to accurately time the point at which echo voltage measurements are sensed, since the first and second steps 110, 120 can be carried out concurrently. In addition, by avoiding the use of piezoelectric drives and sensing elements, safety is improved. In particular, piezoelectric elements can under certain conditions spark, which may ignite flammable materials (e.g. flammable liquids or gases) in the environments within which they are located.

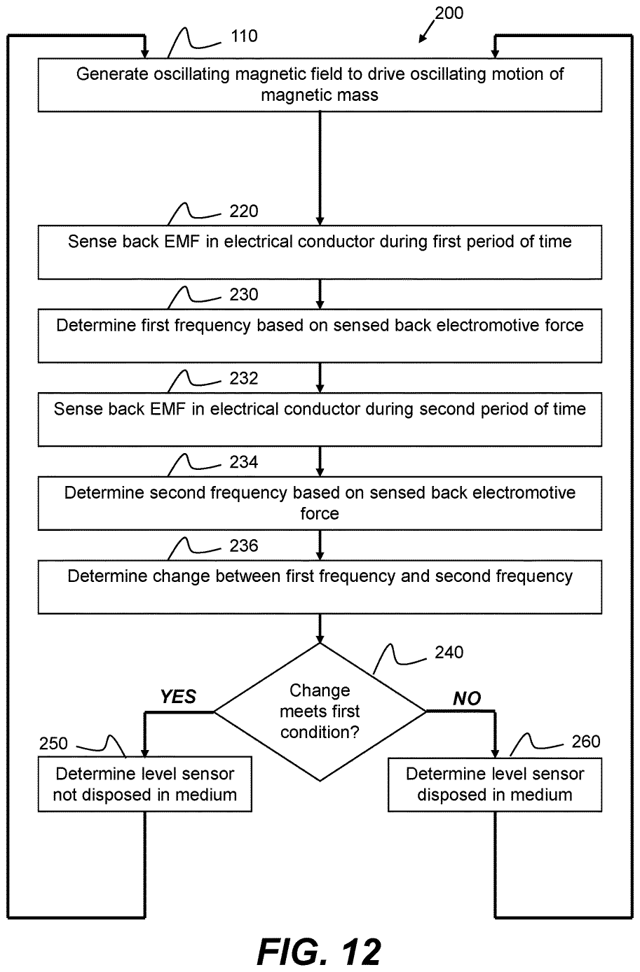

FIG. 12 is a flowchart of a second method 200 of operating the level sensing system 14. The second method 200 substantially corresponds to the first method 100, and corresponding features are denoted using corresponding reference numerals. However, the second method 200 comprises alternative steps 220, 230, 240, 250 and 260 that replace steps 120, 130, 140, 150 and 160, respectively. In addition, the second method 200 includes additional steps 232, 234 and 236.

In step 220 of the second method 200, the sensor 86 senses a back electromotive force in the electrical conductor 82 during a first period of time. This back electromotive force is caused by the oscillating motion of the magnetic mass 78 relative to the electrical conductor 82 during the first period of time. It will be appreciated that steps 110 and 220 may be carried out concurrently. The second method 200 then proceeds to step 230.

In step 230, the processor 62 determines a first frequency based on the back electromotive force sensed during step 220. The frequency determined by the processor 62 may be the frequency of the sensed back electromotive force during the first period of time.

Alternatively, the frequency determined by the processor 62 may be a frequency of the oscillating motion of the magnetic mass 78 during the first period of time determined based on the sensed back electromotive force. The second method 200 then proceeds to step 232.

In step 232 of the second method 200, the sensor 86 senses a back electromotive force in the electrical conductor 82 during a second period of time. The second period of time is after the first period of time. This back electromotive force is caused by the oscillating motion of the magnetic mass 78 relative to the electrical conductor 82 during the second period of time. It will be appreciated that steps 110 and 232 may be carried out concurrently. The second method 200 then proceeds to step 234.

In step 234, the processor 62 determines a second frequency based on the back electromotive force sensed during step 232. The frequency determined by the processor 62 may be the frequency of the sensed back electromotive force during the second period of time. Alternatively, the frequency determined by the processor 62 may be a frequency of the oscillating motion of the magnetic mass 78 during the second period of time determined based on the sensed back electromotive force. The first method 100 then proceeds to step 236.

In step 236, the processor 62 determines a change between the first frequency and the second frequency. By way of a first example, the first frequency may be 182 Hertz and the second frequency may be 170 Hertz, in which case the change in frequency is −12 Hertz. By way of a second example, the first frequency may be 182 Hertz and the second frequency may be 155 Hertz, in which case the change in frequency is −27 Hertz. In the above examples, the change is an actual change.

In step 240, the processor 62 determines whether the determined change meets a first condition. The first condition is the determined change being greater than a threshold value. The threshold value may be any suitable value, for example −20 Hertz. In the first example given above, the determined change of −12 Hertz is determined to have the first condition. In the second example given above, the determined change of −27 Hertz is determined not to have met the first condition. The second method 200 then proceeds to step 250 or step 260 depending on the outcome of step 240.

In step 250, upon determining that the change does meet the first condition, the processor 62 determines that the level sensor 18 is not disposed in the first medium (either partly or wholly). The second method 200 then proceeds to the first step 110 where the second method 200 may be repeated.

In step 260, upon determining that the change does not meet the first condition, the processor 62 determines that the level sensor 18 is disposed in the first medium 12 (either partly or wholly). The second method 200 then proceeds to the first step 110 where the second method 200 may be repeated.

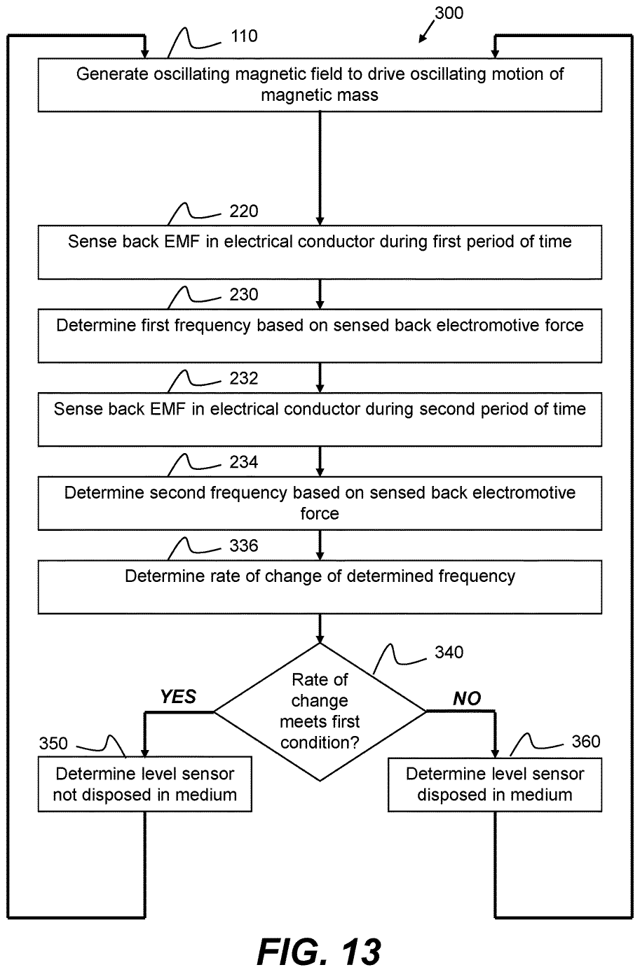

FIG. 13 is a flowchart of a third method 300 of operating the level sensing system 14. The third method 300 substantially corresponds to the second method 200, and corresponding features are denoted using corresponding reference numerals. However, the third method 300 comprises alternative steps 336, 340, 350 and 360 that replace steps 236, 240, 250 and 260, respectively.

In step 336, the processor 62 determines a rate of change of frequency based on the first frequency and the second frequency. By way of a first example, the first frequency may be 182 Hertz at first time of 5 minutes and the second frequency may be 170 Hertz at a second time of 65 minutes, in which case the rate of change is −12 Hertz per hour. By way of a second example, the first frequency may be 182 Hertz at a first time of 5 minutes and the second frequency may be 155 Hertz at a second time of 65 minutes, in which case the rate of change is −27 Hertz per hour.

In step 340, the processor 62 determines whether the rate of change meets a first condition. The first condition is the determined rate of change being greater than a threshold value. The threshold value may be any suitable value, for example −20 Hertz per hour. In the first example given above, the determine rate of change of −12 Hertz per hour is determined to have the first condition. In the second example given above, the determined rate of change of −27 Hertz per hour is determined not to have met the first condition. The third method 300 then proceeds to step 350 or step 360 depending on the outcome of step 340. In the above examples, the rate of change is an actual rate of change.

In step 350, upon determining that the rate of change does meet the first condition, the processor 62 determines that the level sensor 18 is not disposed in the first medium 12 (either partly or wholly). The third method 300 then proceeds to the first step 110 where the third method 300 may be repeated.

In step 360, upon determining that the rate of change does not meet the first condition, the processor 62 determines that the level sensor 18 is disposed in the first medium 12 (either partly or wholly). The third method 300 then proceeds to the first step 110 where the third method 300 may be repeated.

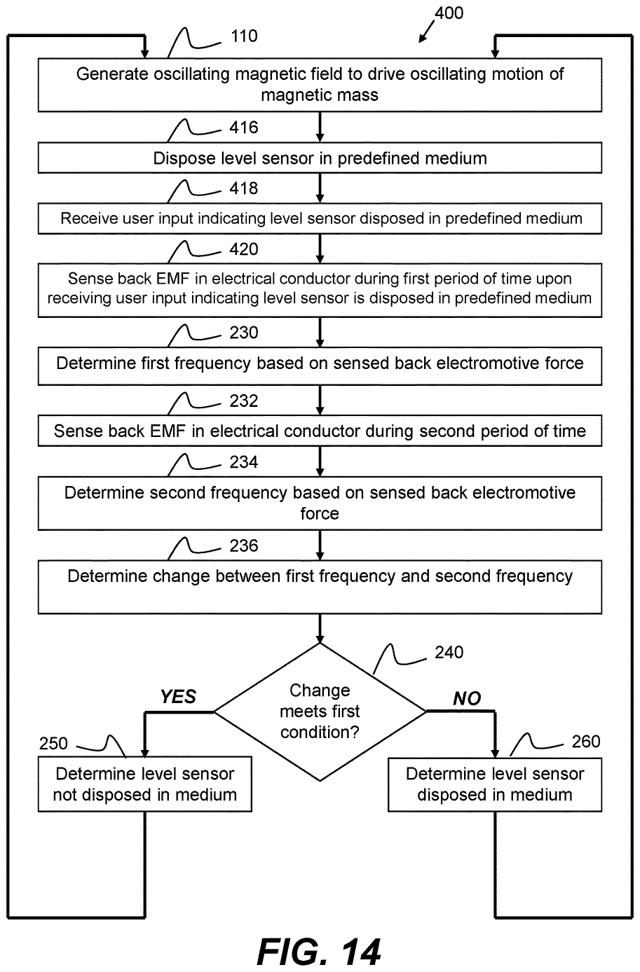

FIG. 14 shows a flowchart of a fourth method 400 of operating the level sensing system 14. The fourth method 400 substantially corresponds to the second method 200, and corresponding features are denoted using corresponding reference numerals. However, the fourth method 400 comprises additional steps 416 and 418. In addition, the fourth method 400 comprises alternative step 420 that replaces step 220.

In step 416, the level sensor 18 is disposed in a predefined medium. The predefined medium may be the second medium 10 (i.e. water) or the third medium 11 (i.e. air).

In step 418, the level sensing system 14 receives a user input indicating that the level sensor 18 is disposed in the predefined medium. For example, the user may press a button indicating that the level sensor 18 is disposed in the second medium, a button indicating that the level sensor 18 is disposed in the third medium or a button indicating that the level sensor 18 is disposed in the first medium. The button or buttons may, for example, be located on the remote telemetry unit 16.

In step 420, the sensor 86 senses a back electromotive force in the electrical conductor 82 during a first period of time upon the level sensing system 14 receiving the user input indicating the level sensor 18 is disposed in the predefined medium. In this manner, future changes in frequency are determined against a baseline frequency determined in a known medium.

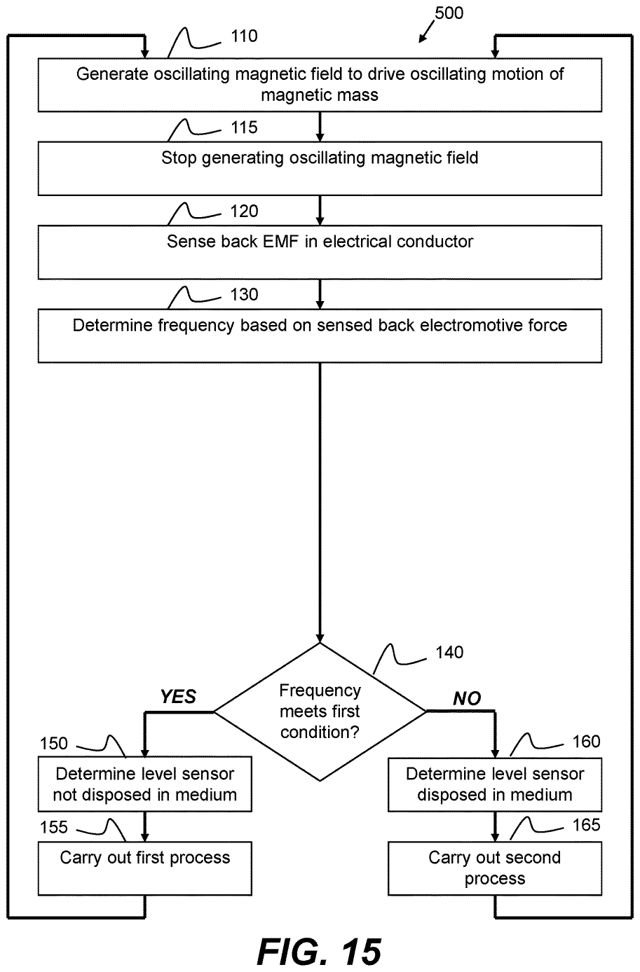

FIG. 15 is a flowchart of a fifth method 500 of operating the level sensing system 14. The fifth method 500 substantially corresponds to the first method 100, and corresponding features are denoted using corresponding reference numerals. However, the fifth method 500 includes additional steps 115, 155 and 165. In alternative embodiments, one or more of the additional steps 115, 155 and 165 may be omitted in the fifth method 500.

Additional step 115 comprises stopping the electrical conductor 82 generating an oscillating magnetic field. Additional step 115 occurs after the first step 110 and prior to the step 120 of sensing the back electromotive force in the electrical conductor 82 caused by the oscillating motion of the magnetic mass (i.e. the second step).

Additional step 155 comprises carrying out a first process upon determining in the fifth step 150 that the level sensor 18 is not disposed at least partly in the medium (e.g. the sediment 12). For example, the first process may be the processor 62 instructing the suction device 9 to stop suction to stop removing sediment 12 from the chamber 4 via the pipe 7.

Alternatively, or additionally, the first process may be the processor 62 generating a signal to stop generating an alarm or notification, for example.

Additional step 165 comprises carrying out a second process upon determining in the sixth step 160 that the level sensor 18 is disposed at least partly in the medium (e.g. the sediment 12). For example, the second process may be the processor 62 instructing the suction device 9 to start suction to remove sediment 12 from the chamber 4 via the pipe 7. Alternatively, or additionally, the first process may be the processor 62 generating a signal to start generating an alarm or notification, for example.

It will be appreciated that the first and second processes described above are only exemplary, and that the determinations carried out during steps 150 and 160 may instead trigger different actions.

It will be appreciated that methods 100, 200, 300, 400, 500 described herein may comprise additional steps to determine whether the frequencies are greater or lower than additional threshold values. In such embodiments (e.g. in which there are two threshold values), the method may determine that the level sensor 18 is disposed in a first medium (e.g. sediment 12) if the frequency is below a first threshold value, determine that the level sensor 18 is disposed in second medium (e.g. water 10) if the frequency is between the first threshold value and a second threshold value greater than the first threshold value, and determine that the level sensor 18 is disposed in a third medium 11 (e.g. air) if the frequency is above the second threshold value.

The use of first conditions have been described in the above methods, and that the first condition may be the determined frequency being greater than a threshold value, the determined change being greater than a threshold value or the determined rate of change being greater than a threshold value. However, it will be appreciated that opposite conditions may instead be used in the methods. For example, a second condition may be used instead, in which case the second conditions may be the determined frequency being less than a threshold value, the determined change being less than a threshold value or the determined rate of change being less than a threshold value. In such embodiments, the outcome of the determinations are opposite. It will further be appreciated that the first condition can be determined without determining second condition and vice versa.

Although it has been described that the level sensor 18 is connected to the remote telemetry unit 16 by a wire 20 through which signals are exchanged (i.e. they are hardwired together), in alternative embodiments the wire 20 may be omitted and signals may be exchanged between the components wirelessly. In contrast, although it has been described that the remote telemetry unit 16 is connected to the remote control system 19 via a wireless connection 21, in alternative embodiments they may be connected by a physical wire through which signals are exchanged.

Although it has been described that the level sensor 18 comprises the processor 62, it will be appreciated that other parts of the level sensing system 14 may instead comprise the processor 62. For example, the processor 62 may be disposed in the remote telemetry unit 16. In such embodiments, one or more steps of the method may be carried out at the remote telemetry unit 16. Alternatively, the processor 62 may be disposed in the remote control system 19. In such embodiments, one or more steps of the method may instead be carried out at the remote control system 19.

It will further be appreciated that the processor 62 may be formed of multiple distinct processors that are located at multiple places in the level sensing system 14. For example, the processor 62 may be formed of a processor at the level sensor 18, a processor at the remote telemetry unit 16 and a processor at the remote control system 19. Alternatively, the processor 62 may be formed of a processor at the level sensor 18 and a processor at the remote telemetry unit 16. Alternatively, the processor 62 may be formed of a processor at the level sensor 18 and a processor at the remote control system 19. Alternatively, the processor 62 may be formed of a processor at the remote telemetry unit 16 and a processor at the remote control system 19. In such embodiments, one or more steps of the method may be carried out at different locations within the level sensing system 14.

It will be appreciated that various data including instructions for carrying out the methods described herein and values recorded by the level sensing system 14 may be stored in memory located anywhere in the level sensing system 14, for example in the level sensor 18 and/or the remote telemetry unit 16 and/or the remote control system 19.

Although it has been described that the change is an actual change and the rate of change is an actual rate of change, the change may alternatively be a relative change (e.g. a percentage change) and the rate of change may alternatively be a relative rate of change (e.g. a percentage rate of change).

It will be appreciated that features of certain methods have been described with reference to a single method but they can be incorporated into one or more of the other methods. For example, the additional and alternative steps of the fourth method 400, which are modifications of the second method 200, can be instead incorporated into the third method 300. In addition, the additional steps of the fifth method 500, which are modifications of the first method 100, can instead be incorporated into any of the second, third and fourth methods 200, 300, 400.

It will be appreciated that the order of certain steps of the methods are exemplary, and that they may be different in alternative embodiments. By way of example, step 232 can be carried out prior to step 230. Additionally or alternatively, step 230 can be carried out after step 234.

Although it has been described that the level sensing system comprises multiple components including a level sensor, it will be appreciated that the level sensing system may exclusively comprise (i.e. consist of) a level sensor.

1. A level sensing system comprising a level sensor, the level sensor being configured to be disposed in at least a first medium and a second medium, the level sensor comprising:
a sensor housing;
a spring-mass system disposed within the sensor housing, the spring-mass system comprising a magnetic mass and a spring that couples the magnetic mass to the sensor housing;
an electrical conductor configured to generate an oscillating magnetic field for driving oscillating motion of the magnetic mass; and
a sensor configured to sense a back electromotive force in the electrical conductor caused by the oscillating motion of the magnetic mass,
wherein the level sensing system comprises a processor configured to:
determine a frequency based on the sensed back electromotive force, the frequency being a frequency of the sensed back electromotive force or a frequency of the oscillating motion of the magnetic mass;
determine whether the determined frequency meets a first condition and/or meets a second condition, wherein the first condition is the determined frequency being greater than a threshold value, wherein the second condition is the determined frequency being less than a threshold value;
determine that the level sensor is not disposed partly or wholly in the first medium and/or determine that the level sensor is disposed partly or wholly in the second medium upon determining that the determined frequency meets the first condition and/or does not meet the second condition; and
determine that the level sensor is disposed partly or wholly in the first medium and/or determine that the level sensor is not disposed partly or wholly in the second medium upon determining that the determined frequency does not meet the first condition and/or does meet the second condition.

2. A level sensing system comprising a level sensor, the level sensor being configured to be disposed in at least a first medium and a second medium, the level sensor comprising:
a sensor housing;
a spring-mass system disposed within the sensor housing, the spring-mass system comprising a magnetic mass and a spring that couples the magnetic mass to the sensor housing;
an electrical conductor configured to generate an oscillating magnetic field for driving oscillating motion of the magnetic mass; and
a sensor configured to sense a back electromotive force in the electrical conductor caused by the oscillating motion of the magnetic mass during a first period of time and sense a back electromotive force in the electrical conductor caused by the oscillating motion of the magnetic mass during a second period of time after the first period of time,
wherein the level sensing system comprises a processor configured to:
determine a first frequency based on the sensed back electromotive force, the first frequency being a frequency of the sensed back electromotive force or a frequency of the oscillating motion of the magnetic mass during the first period of time;
determine a second frequency based on the sensed back electromotive force, the second frequency being a frequency of the sensed back electromotive force or a frequency of the oscillating motion of the magnetic mass during the second period of time;
determine a change between the first frequency and the second frequency or determine a rate of change of frequency based on the first frequency and the second frequency;
determine whether the determined change or the determined rate of change meets a first condition and/or meets a second condition, wherein the first condition is the determined change being greater than a threshold value or the determined rate of change being greater than a threshold value, wherein the second condition is the determined change being less than a threshold value or the determined rate of change being less than a threshold value;
determine that the level sensor is not disposed partly or wholly in the first medium and/or determine that the level sensor is disposed partly or wholly in the second medium upon determining that the determined change or rate of change does meet the first condition and/or does not meet the second condition; and
determine that the level sensor is disposed partly or wholly in the first medium and/or determine that the level sensor is not disposed partly or wholly in the second medium upon determining that the determined change or rate of change does not meet the first condition and/or does meet the second condition.

3. The level sensing system as set forth in claim 2, wherein the sensor is configured to sense the back electromotive force in the electrical conductor caused by the oscillating motion of the magnetic mass during the first period of time upon the level sensing system receiving a user input indicating the level sensor is disposed in a predefined medium.

4. The level sensing system as set forth in claim 1, wherein the level sensor further comprises a supporting arm to which the sensor housing is attached, wherein the oscillating motion of the magnetic mass effects oscillating motion of the supporting arm.

5. The level sensing system as set forth in claim 4, wherein the supporting arm is formed by a printed circuit board.

6. The level sensing system as set forth in claim 4, wherein the sensor housing and the supporting arm are disposed at least in part within a flexible casing configured to seal the sensor housing from an external environment.

7. The level sensing system as set forth in claim 6, wherein the elasticity of the flexible casing is greater than the elasticity of the supporting arm.

8. The level sensing system as set forth in claim 6, wherein the level sensor further comprises a rigid casing, wherein the flexible casing is disposed at least partly within the rigid casing.

9. The level sensing system as set forth in claim 8, wherein the rigid casing comprises an opening, wherein the flexible casing is exposed to the external environment through the opening.

10. The level sensing system as set forth in claim 9, wherein the rigid casing comprises a first prong and a second prong that extend from a base of the rigid casing, wherein the first prong and the second prong are separated by a gap and at least in part define the opening.

11. The level sensing system as set forth in claim 10, wherein the flexible casing is disposed at least in part within the gap, and wherein the sensor housing is disposed between the first and second prongs.

12. The level sensing system as set forth in claim 11, wherein the magnetic mass, the spring and the electrical conductor are aligned along an axis that extends through the gap.

13. The level sensing system as set forth in claim 11, wherein the width of a portion of the flexible casing disposed at least in part within the gap measured in the direction of the axis tapers toward a distal end of the flexible casing.

14. The level sensing system as set forth in claim 12, wherein the width of the first prong measured in the direction of the axis and the width of the second prong measured in the direction of the axis is less than the width of the base measured in the direction of the axis.

15. The level sensing system as claimed in claim 1, wherein the first and second prongs extend from the base beyond a distal end of the flexible casing.

16. The level sensing system as set forth in claim 1, wherein the processor is disposed within the base.

17. The level sensing system as set forth in claim 1, wherein the level sensor comprises the processor.

18. The level sensing system as set forth in claim 1, further comprising a transmitter configured to wirelessly transmit the sensed back electromotive force to a remote location, wherein the remote location comprises the processor.

19. A method of operating the level sensing system as set forth in claim 1, the method comprising:
generating, by the electrical conductor, an oscillating magnetic field to drive oscillating motion of the magnetic mass;
sensing, by the sensor, a back electromotive force in the electrical conductor caused by the oscillating motion of the magnetic mass
determining, by the processor, a frequency based on the sensed back electromotive force, the frequency being a frequency of the sensed back electromotive force or a frequency of the oscillating motion of the magnetic mass;
determining, by the processor, whether the determined frequency meets a first condition and/or meets a second condition, wherein the first condition is the determined frequency being greater than a threshold value, wherein the second condition is the determined frequency being less than a threshold value;
determining, by the processor, that the level sensor is not disposed partly or wholly in the first medium and/or determine that the level sensor is disposed partly or wholly in the second medium upon determining that the determined frequency meets the first condition and/or does not meet the second condition; and
determining, by the processor, that the level sensor is disposed partly or wholly in the first medium and/or determine that the level sensor is not disposed partly or wholly in the second medium upon determining that the determined frequency does not meet the first condition and/or does meet the second condition.

20. A method of operating the level sensing system as set forth in claim 1, the method comprising:
generating, by the electrical conductor, an oscillating magnetic field to drive oscillating motion of the magnetic mass;
sensing, by the sensor, a back electromotive force in the electrical conductor caused by the oscillating motion of the magnetic mass during a first period of time and sensing a back electromotive force in the electrical conductor caused by the oscillating motion of the magnetic mass during a second period of time after the first period of time;
determining, by the processor, a first frequency based on the sensed back electromotive force, the first frequency being a frequency of the sensed back electromotive force or a frequency of the oscillating motion of the magnetic mass during the first period of time;
determining, by the processor, a second frequency based on the sensed back electromotive force, the second frequency being a frequency of the sensed back electromotive force or a frequency of the oscillating motion of the magnetic mass during the second period of time;
determining, by the processor, a change between the first frequency and the second frequency or determining a rate of change of frequency based on the first frequency and the second frequency;
determining, by the processor, whether the determined change or the determined rate of change meets a first condition and/or meets a second condition, wherein the first condition is the determined change being greater than a threshold value or the determined rate of change being greater than a threshold value, wherein the second condition is the determined change being less than a threshold value or the determined rate of change being less than a threshold value;
determining, by the processor, that the level sensor is not disposed partly or wholly in the first medium and/or determine that the level sensor is disposed partly or wholly in the second medium upon determining that the determined change or rate of change meets the first condition and/or does not meet the second condition; and
determining, by the processor, that the level sensor is disposed partly or wholly in the first medium and/or determine that the level sensor is not disposed partly or wholly in the second medium upon determining that the determined change or rate of change does not meet the first condition and/or does meet the second condition.

21. The method as set forth in claim 20, further comprising:
disposing the level sensor in a predefined medium;
the level sensing system receiving a user input indicating the level sensor is disposed in the predefined medium; and
sensing, by the sensor, the back electromotive force in the electrical conductor caused by the oscillating motion of the magnetic mass during the first period of time upon the level sensing system receiving the user input indicating the level sensor is disposed in the predefined medium.

22. The method as set forth in claim 19, wherein the steps of generating, by the electrical conductor, an oscillating magnetic field to drive oscillating motion of the magnetic mass and sensing, by the sensor, a back electromotive force in the electrical conductor caused by the oscillating motion of the magnetic mass are carried out concurrently.

23. The method as set forth in claim 19, further comprising:
stopping generating, by the electrical conductor, the oscillating magnetic field prior to sensing, by the sensor, the back electromotive force in the electrical conductor caused by the oscillating motion of the magnetic mass.

24. The method as set forth in claim 19, further comprising:
upon determining that the level sensor is not disposed at least partly in the medium, carrying out a first process; and
upon determining that the level sensor is disposed at least partly in the medium, carrying out a second process.
